(19) United States
(12) Patent Application Publication
(10) Pub. No.: US 2009/0114047 A1
(43) Pub. Date: May 7, 2009

(54) Gear Assembly

(75) Inventors: Tristan Richard Ghislain Davenne, West Sussex (GB); John Cambridge Smith, West Sussex (GB)

Correspondence Address: The BOC Group, Inc., 575 MOUNTAIN AVENUE, MURRAY HILL, NJ, 07974-2082, US

(73) Assignee: Ira Lee Zebrak The BOC Group, Inc., Legal-Services-IP, Murray Hill, NJ (US)

(21) Appl. No.: 10/594,260

(22) PCT Filed: Mar. 22, 2005
(86) PCT No.: PCT/GB05/01087

§ 371 Date: Oct. 29, 2007

(30) Foreign Application Priority Data
Mar. 26, 2004 (GB) 0406887.0

(51) Int. Cl. F16H 55/14; F04C 2/18

(52) U.S. Cl. 74/411; 418/206.5

(57) ABSTRACT

A gear assembly for transmitting torque from one shaft to another comprises two intermeshing gears mounted on respective shafts. One of the gears comprises a hub member for receiving one of the shafts, a toothed annular member mounted for rotation with the hub member. At least one spring provided between the hub member and the annular member has stiffness capable of reducing torsional vibrations and noise induced during rotation of the gears by the eccentricity of at least one of the gears.

The present invention relates to a gear assembly for transmitting torque from one shaft to another, and to a gear suitable for use in such an assembly. The gear s assembly is particularly useful for transmitting torque between shafts of a vacuum pump.

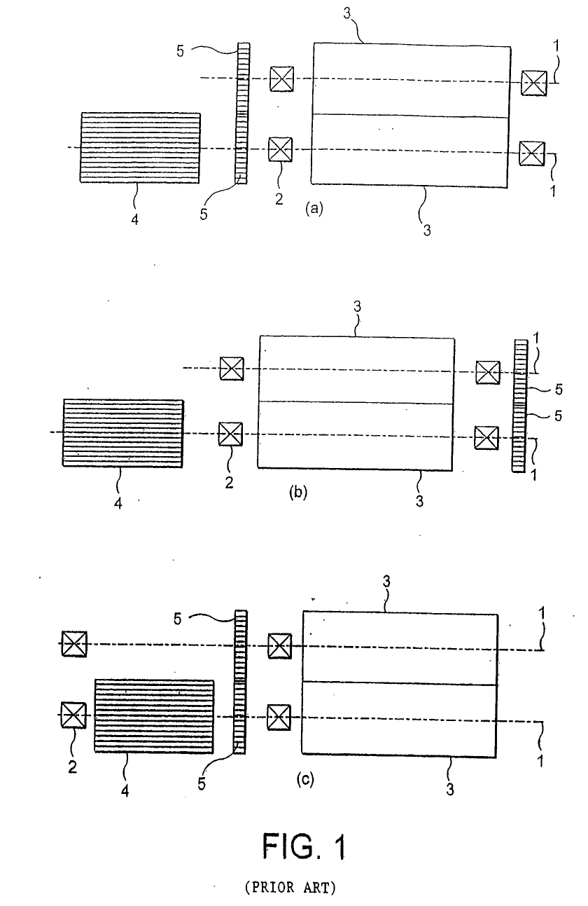

With reference to FIG. 1, a known vacuum pump includes a pumping chamber through which pass a pair of parallel shafts 1 supported by bearings 2. A rotor 3 to is mounted on each shaft 1 for rotation within the pumping chamber. The rotors 3 have complementary pumping profiles, which may be Roots, Northey (or “claw”) or screw. In use, when a motor 4 is driving one of the shafts 1, the other shaft is rotated synchronously with that shaft by means of the meshed timing gears 5. The rotors 3 are so profiled that fluid to be pumped is drawn into an inlet of the pumping chamber and exits from the pumping chamber via an outlet.

FIG. 1 illustrates three different pumping configurations. In FIG. 1(a), the rotors 3 are mounted between the bearings 2 and the timing gears 5 are provided at the motor-driven end of the pump. In FIG. 1(b), the timing gears 5 are provided at the other end of the pump, and FIG. 1(c) illustrates a configuration using cantilevered rotors.

Transmission of torque through the meshed gears 5 is affected by gear eccentricity. Gear eccentricity results in an oscillating drive torque, which would normally be constant with concentric gears. In the case of high inertia, lightly loaded, rotating machinery driven by gears with typical manufacturing eccentricity tolerances, the magnitude of the oscillating drive torque can exceed the steady state drive torque. As a result, the gears leave mesh, which can provoke high frequency tooth-to-tooth slapping, a characteristic noise frequently encountered in lightly loaded rotating machinery.

Pump design has been improved to reduce friction and power consumption. Consequently the required steady state drive torque has reduced and thus rotating machinery has become increasingly prone to eccentricity induced torsional vibrations and related noise problems.

It is an aim of at least the preferred embodiment of the present invention to reduce such torsional vibrations and noise by accommodating typical gear eccentricities.

In one aspect, the present invention provides a gear assembly for transmitting to torque from one shaft to another, the gear assembly comprising two intermeshing gears mounted on respective shafts, one of the gears comprising a hub member for receiving one of the shafts, a toothed annular member mounted for rotation with the hub member, and means provided between the hub member and the annular member having a stiffness capable of reducing torsional vibrations and noise induced during rotation of the gears by eccentricity of at least one of the gears.

The means for inhibiting torsional vibrations and noise preferably comprises a resilient coupling between the hub member and the annular member. This coupling is preferably located between opposing surfaces of the members. In the preferred embodiment, the resilient coupling is located within a drive mechanism for transferring torque between the members. For example, one member may comprise one or more recesses each for receiving a detent of the other member for transferring torque between the members, the resilient coupling being located between opposing surfaces of the or each recess and detent.

The means for inhibiting torsional vibrations and noise thus preferably comprises at least one resilient member located between opposing surfaces of the members. In the preferred embodiment, a plurality of resilient members are each located between respective opposing surfaces of the members.

The resilient members may be conveniently provided by a number of springs, for example, metal torsional springs or translational springs including flat, disc and coil springs acting along a tangential line within the radius of the member. Alternatively, repelling magnets could be used with the resulting stiffness being proportional to the magnetic flux. Finally in some applications use of viscoelastic materials may be appropriate.

Providing means such as a spring between the hub member and the annular member can allow the torsional stiffness of the gear to be controlled. By providing a spring between the members the inertia that is accelerated and decelerated due to eccentricity is reduced. As the gear is accelerated, the spring is designed to compress so that the shaft can remain at a constant speed. This isolation of the shaft from eccentricity-induced gear acceleration reduces the oscillations in drive torque and will increase the eccentricity at which the gears will leave mesh.

In the event of an external torque other than that resulting from gear eccentricity causes the gears to leave mesh, the spring will act to absorb the impact that occurs as the gears come back into mesh and thus act to bring the assembly back to the linear, in-mesh, operating region. In support of this argument, non-linear analysis of tooth-to-tooth slapping has shown that the gears can only leave mesh if the overall torsional stiffness is above a certain level. In other words, low torsional stiffness rotating machinery (‘weak shafts’) would always remain in mesh.

This aspect of the invention extends to a vacuum pump comprising at least two shafts connected together by a gear assembly as aforementioned. For example, a high-speed Roots blower vacuum pump includes Roots profile rotors rotating In a pumping chamber with a 1:1 gear ratio. Torsional vibrations between the gears can be a problem when operating at maximum speed and ultimate pressure (the best vacuum achievable by the pump). The noise generated has been shown to depend on gear eccentricity, and is present with the available manufacturing gear wheel tolerances. An experimental prototype gear according to the invention fitted to the driven shah has been shown to eliminate gear tooth-to-tooth slapping with gear eccentricities that normally result in a pump prone to this noise problem.

In another aspect the present invention provides a gear for transmitting torque from one shaft to another, the gear comprising a hub member for receiving one of the shafts, a toothed annular member mounted for rotation with the hub member, and means provided between the hub member and the annular member having a stiffness capable of reducing torsional vibrations and noise induced during use by the eccentricity of the annular member.

A further aspect of the invention provides use of at least one spring in a gear of a gear assembly to reduce torsional vibrations and noise induced during rotation of the gears by the eccentricity of at least one of the gears.

Preferred features of the present invention will now be described, by way of example only, with reference to the accompanying drawings, in which.

FIG. 1 illustrates schematically three known pump configurations;

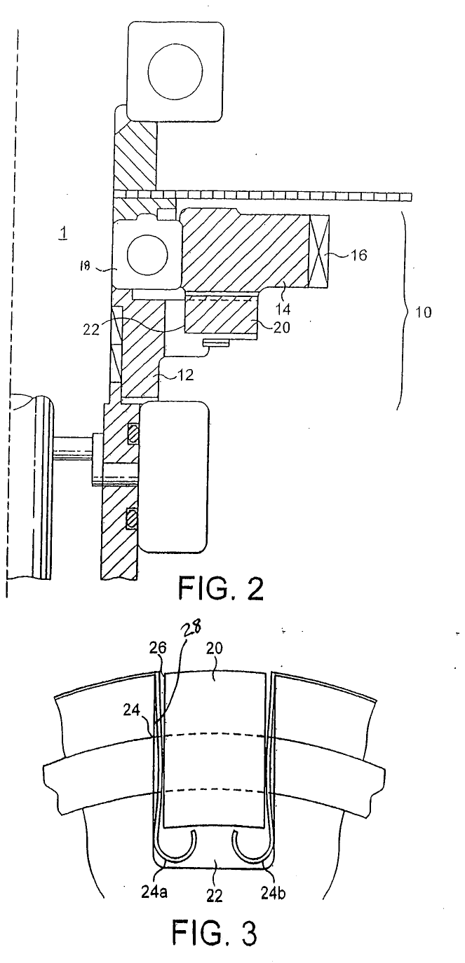

FIG. 2 is a cross-section of a gear suitable for use in any of the pumps of FIG. 1; and

FIG. 3 is a cross-section illustrating the mechanism for transmitting torque between the hub member and annular member of the gear of FIG. 2.

With reference to FIG. 2, a gear 10 suitable for use In any of the vacuum pumps shown in FIG. 1 or in any other lightly loaded, high Inertia rotating machine comprises a hub member 12 for receiving a shaft of the pump and an annular member 14 mounted for rotation with the hub member 12 and having peripheral teeth 16, The shaft received by the hub member 12 may be either a drive shaft or a driven shaft of the pump. A bearing assembly 18 is carried by the bore of the annular member 14 and the shaft.

In use, the peripheral teeth 16 of the annular member 14 are int meshing engagement with the corresponding teeth of another gear having a 1:1 gear ratio with the gear 10, similar to the timing gears 5 shown in FIG. 1.

A drive mechanism for transmitting torque between the members 12, 14 is provided by a plurality of detents provided around a surface perpendicular to the rotational axis of one of the members which enter respective recesses provided around the facing axial surface of the other member. In the embodiment shown in lo FIG. 2, detents 20 are provided on the annular member 14 and recesses 22 are provided on the hub member 12, although this could be the other way around, with the detents being provided on the hub member and the recesses provided on the annular member.

As shown in FIG. 3, flat springs 24a, 24b are located within each recess 22 between the facing radial surfaces 26, 28 of the detent 20 and recess 22. The springs 24a, 24b have a stiffness chosen to substantially inhibit torsional vibrations and noise induced under lightly loaded conditions by eccentricity of either the annular member 14 or of the gear meshing with the teeth 16 of the annular member 14. The springs 24a, 24b also provide absorption of any tooth-to-tooth impact resulting from external disturbances.

Under lightly loaded conditions, as experienced by a pump operating at ultimate pressure, the transmission of torque between the members 12, 14 is through one of the springs 24a, 24b provided within each recess 22. This provides a degree of resilience necessary to accommodate any gear eccentricity.

In the event of the pump being subject to higher loads where a solid drive is needed to avoid compromising the phase relationship between the driving and driven shafts, the spring flattens between the facing radial surfaces 26, 28 once the angular deflection of the spring has reached a specified value above a predetermined drive torque. This provides the necessary solid drive between the radial faces 26, 28.

Whilst in this embodiment flat springs have been used to control torsional stiffness, tangentially mounted disc springs or coil springs could be used instead. Alternatively, repelling magnets could be used, with the resulting torsional stiffness being proportional to the magnetic flux. In some applications, use of viscoelastic materials may be appropriate.

1. A gear assembly for transmitting torque from one shaft to another comprising:
two intermeshing gears mounted on respective shafts, one of the gears comprising a hub member for receiving one of the shafts;
a toothed annular member mounted for rotation with the hub member; and
means for reducing torsional vibrations and noise provided between the hub member and the annular member and having a stiffness capable of reducing torsional vibrations and noise induced during rotation of the gears by the eccentricity of at least one of the gears.

2. The gear assembly according to claim 1 wherein the means for reducing torsional vibrations and noise comprises means for increasing the critical eccentricity of the gear.

3. The gear assembly according to claim 1 wherein the means for reducing torsional vibrations and noise comprises a resilient coupling between the hub member and the annular member.

4. The gear assembly according to claim 1 wherein the means for reducing torsional vibrations and noise is located between a radial surface of the hub member and an opposing radial surface of the annular member.

5. The gear assembly according to claim 1 wherein the means for reducing torsional vibrations and noise is located within a drive mechanism for transferring torque between the hub member and the annular member.

6. The gear assembly according to claim 5 wherein one of the hub member and the annular member comprises a recess for receiving a detent of the other of the hub member and the annular member for transferring torque between the hub member and the annular member, the means for reducing torsional vibrations and noise being located between opposing surfaces of the recess and the detent.

7. The gear assembly according to claim 6 wherein said one of the hub member and the annular member comprises a plurality of said recesses each for receiving a respective detent of the other of the hub member and the annular member, the means for reducing torsional vibrations and noise being located between opposing surfaces of each recess and detent.

8. The gear assembly according to claim 1 wherein the means for inhibiting torsional vibrations and noise comprises at least one resilient member located between opposing surfaces of the hub member and the annular member.

9. The gear assembly according to claim 8 wherein the means for inhibiting torsional vibrations and noise comprises, a plurality of resilient members each located between respective opposing surfaces of the hub member and the annular member.

10. The gear assembly according to claim 9 wherein each resilient member comprises a spring for providing torsional resistance.

11. The gear assembly according to claim 9 wherein each resilient member comprises a plurality of springs for providing torsional resistance.

12. The gear assembly according to claim 9 wherein each resilient member comprises a viscoelastic member.

13. The gear assembly according to claim 1 wherein the means for reducing torsional vibrations and noise comprises mutually repelling magnets provided on opposing surfaces of the hub member and the annular member.

14. The gear assembly according to claim 1 wherein the means for reducing torsional vibrations and noise is arranged to maintain the phase relationship between the shafts.

15. The gear assembly according to claim 14 wherein the means for reducing torsional vibrations and noise is arranged to permit a solid drive to be established between the hub member and the annular member above a predetermined drive torque.

16. A vacuum pump comprising at least two shafts connected together by a gear assembly comprising two intermeshing gears mounted on respective shafts, one of the gears comprising a hub member for receiving one of the shafts;
a toothed annular member mounted for rotation with the hub member; and
means for reducing torsional vibrations and noise provided between the hub member and the annular member and having a stiffness capable of reducing torsional vibrations and noise induced during rotation of the gears by the eccentricity of at least one of the gears.

17. A gear for transmitting torque from one shaft to another comprising;
a hub member for receiving one of the shafts;
a toothed annular member mounted for rotation with the hub member; and
means provided between the hub member and the annular member having a stiffness capable of reducing torsional vibrations and noise induced during use by eccentricity of the annular member.

18. (canceled)
